(19) United States
(12) Patent Application Publication
(10) Pub. No.: US 2025/0022276 A1
(43) Pub. Date: Jan. 16, 2025

(54) MONITORING SYSTEM AND NON-TRANSITORY COMPUTER-READABLE STORAGE MEDIUM

(71) Applicant: KONICA MINOLTA, INC., Tokyo (JP)

(72) Inventor: Shimpei ITAYA, Tokyo (JP)

(73) Assignee: KONICA MINOLTA, INC., Tokyo (JP)

(21) Appl. No.: 18/768,581

(22) Filed: Jul. 10, 2024

(30) Foreign Application Priority Data
Jul. 13, 2023 (JP) 2023-115053

(51) Int. Cl. G06V 20/52; G06T 7/20; G06V 40/16; G08B 21/24

(52) U.S. Cl. CPC G06V 20/52; G06T 7/20; G06V 40/16; G06T 2207/30196; G06T 2207/30232; G08B 21/24

(57) ABSTRACT

A monitoring system includes: an imaging section that captures an image of a user present within a predetermined imaging range and belongings of the user; and a hardware processor performs: detecting that the user has left the belongings based on the image captured by the imaging section; detecting that another person different from the user has approached the belongings; and notifying the user when it is detected that the user has left the belongings and it is detected that another person different from the user has approached the belongings.

### CROSS REFERENCE TO RELATED APPLICATIONS

The present application is based on Japanese Patent Application No. 2023-115053 filed on Jul. 13, 2023, the contents of which are incorporated herein by reference.

### BACKGROUND OF THE INVENTION

### Technical Field

The present invention relates to a monitoring system and a non-transitory computer-readable recording medium.

### Description of the Related Art

In recent years, the number of users who perform telework by using a co-working space or the like has increased. However, not only a person of the same company as the user but also a person of another company may be present in the co-working space. In such a situation, for example, in a case where the user leaves his/her belongings on a desk during telework, there is a possibility that the belongings of the user is browsed by another person and confidential information is leaked.

Conventionally, an apparatus has been proposed in which a package and an owner of the package are associated with each other so that a notification is performed when the owner forgets the package (for example, patent literature 1: JP 2006-166058A). In this conventional art, a sensor detects that an owner has placed a package in a vehicle, and it is determined that the package has been placed on a net shelf based on image data captured by an omnidirectional camera and sensor data. In addition, in this conventional art, the package and the owner are associated with each other, and in a case where a distance between the package and the owner is equal to or greater than a predetermined threshold value in a state where a position of the package is not changed based on a relative positional relationship between the package and the owner, it is determined that the package is a lost item, and the lost item is notified.

The above-mentioned conventional art is intended to prevent forgotten items. However, even if the above-described conventional art is applied, it is not possible to reduce the possibility of leakage of confidential information when a user leaves his/her seat with his/her belongings left on a desk in the middle of telework in a co-working space or the like.

### SUMMARY OF THE INVENTION

In order to solve the conventional problem described above, an object of the present invention is to provide a monitoring system and a non-transitory computer-readable recording medium that can reduce the possibility that confidential information leaks out in a case where a user has left his/her belongings.

To achieve the above object, first, the present invention is directed to a monitoring system.

In one aspect of the present invention, the monitoring system includes: an imaging section that captures an image of a user present within a predetermined imaging range and belongings of the user; and the hardware processor performs: detecting that the user has left the belongings based on the image captured by the imaging section; detecting that another person different from the user has approached the belongings; and notifying the user when it is detected that the user has left the belongings and it is detected that another person different from the user has approached the belongings.

In another aspect of the present invention, the monitoring system includes: an imaging section that captures an image of a user present within a predetermined imaging range and belongings of the user; and the hardware processor performs: detecting that the user has left the belongings based on the image captured by the imaging section; detecting that the belongings has moved within the imaging range based on the image captured by the imaging section; and notifying the user when it is detected that the user has left the belongings and it is detected that the belongings has moved.

Second, the present invention is directed to a non-transitory computer-readable recording medium. In the present invention, the recording medium records a program executed in a monitoring system including an imaging section that images a user existing within a predetermined imaging range and belongings of the user.

In one aspect of the present invention, the program causes the monitoring system to perform: detecting that the user has left the belongings based on an image captured by the imaging section; detecting that the belongings has moved within the imaging range based on an image captured by the imaging section; and notifying to the user when it is detected that the user has left the belongings and it is detected that the belongings has moved.

### BRIEF DESCRIPTION OF THE DRAWINGS

The advantages and features provided by one or more embodiments of the invention will become more fully understood from the detailed description given herein below and the appended drawings which are given by way of illustration only, and thus are not intended as a definition of the limits of the present invention.

FIG. 1 illustrates an example of the configuration of a monitoring system;

FIG. 2 is a block diagram illustrating a functional configuration of a monitoring system;

FIG. 3 is a flowchart illustrating a processing procedure by a mobile terminal and a monitoring apparatus;

FIG. 4 is a flowchart illustrating an example of a detailed processing procedure of the belongings registration processing;

FIGS. 5A and 5B illustrate an example in which the monitoring apparatus detects the belongings of the user;

FIG. 6 illustrate reference information;

FIG. 7 is a flowchart illustrating an example of a detailed processing procedure of the belongings monitoring processing;

FIG. 8 illustrates a concept of processing by a notification processing section;

FIG. 9 is a flowchart illustrating an example of a detailed processing procedure of belongings monitoring processing different from FIG. 7;

FIG. 10 is a flowchart illustrating an example of a detailed processing procedure of belongings monitoring processing in the second embodiment; and

FIG. 11A and FIG. 11B illustrate the concept of processing by a notification processing section.

### DETAILED DESCRIPTION OF EMBODIMENTS

Hereinafter, one or more embodiments of the present invention will be described with reference to the drawings. However, the scope of the invention is not limited to the disclosed embodiments.

Hereinafter, preferred embodiments of the present invention will be described in detail with reference to the drawings. Note that elements common to the embodiments described below are denoted by the same signs, and redundant description thereof is omitted.

### First Embodiment

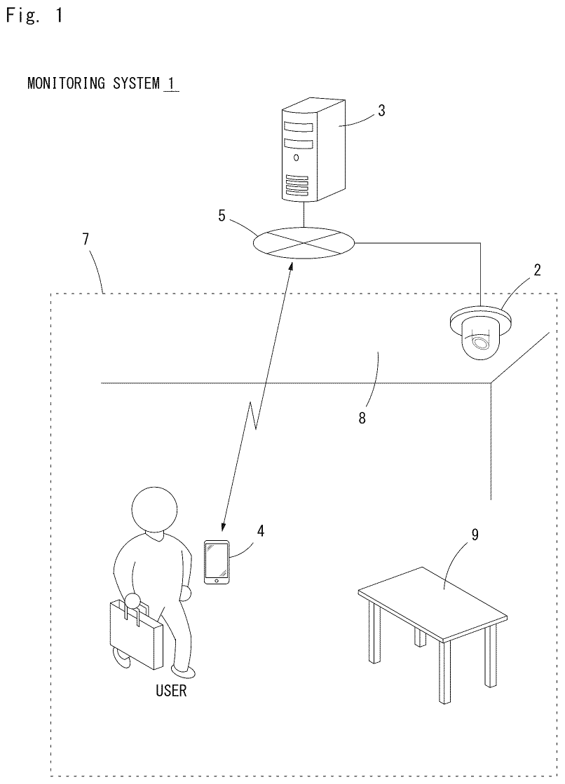

FIG. 1 illustrates an example of the configuration of a monitoring system 1 according to an embodiment of the present invention. The monitoring system 1 is a system that is installed in a co-working space 7 used by various people and monitors a security risk when a particular user moves away from a workspace. For example, when the user enters the co-working space 7, the user uses a desk or the like that is not used by anyone as the working space 9, and performs telework.

The monitoring system 1 includes a monitoring camera 2, a monitoring apparatus 3, and a mobile terminal 4. The monitoring camera 2, the monitoring apparatus 3, and the mobile terminal 4 can communicate with each other via a network 5. The network 5 includes both a wired network and a wireless network. The monitoring camera 2 is installed, for example, on a ceiling 8 or the like of a co-working space 7, and captures an image within a predetermined imaging range. The monitoring apparatus 3 is configured by, for example, a computer, and executes main processing for monitoring security risks. The mobile terminal 4 is a terminal carried by a user who performs telework or the like in the co-working space 7, and is, for example, a tablet terminal or a smartphone.

FIG. 1 illustrates a case where the monitoring camera 2 and the monitoring apparatus 3 are configured as separate bodies. However, the monitoring camera 2 and the monitoring apparatus 3 may be incorporated in one apparatus. For example, the monitoring camera 2 may have a function of the monitoring apparatus 3 described later.

When the user starts telework in the workspace 9, the monitoring system 1 detects the user's belongings placed in the workspace 9 by the user, and manages the user's belongings as a monitoring target. Thereafter, the monitoring system 1 determines, based on an image captured by the monitoring camera 2, whether the user has left the belongings placed in the workspace 9. Upon determining that the user has left the belongings, the monitoring system 1 further determines whether another person different from the user is approaching the belongings of the user placed in the workspace 9. As a result, when determining that the user has left his/her belongings and that another person is approaching the user's belongings, the monitoring system 1 determines that there is a possibility of leakage of confidential information, and provides a notification to the user who is away from the workspace 9. Thus, the user immediately notices that a security risk is occurring, and returns to the workspace 9, thus preventing leakage of confidential information. Hereinafter, such a monitoring system 1 will be described in detail.

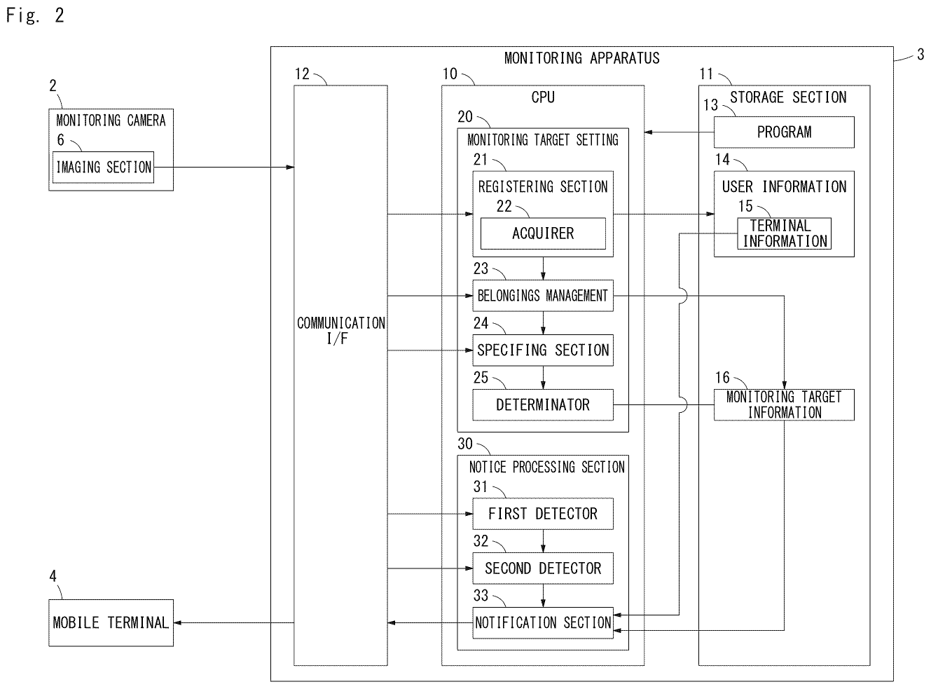

FIG. 2 is a block diagram illustrating a functional configuration of the monitoring system 1. The monitoring camera 2 includes an imaging section 6. The imaging section 6 captures an image of the user and the user's belongings present within a predetermined image capturing range, and outputs the captured image. The image captured by the imaging section 6 may be a still image or a moving image. However, in order to make it possible to detect a security risk in real time in the monitoring system 1, the imaging section 6 preferably captures an image within the imaging range as a moving image. The imaging section 6 outputs an image obtained by imaging the inside of the predetermined imaging range to the monitoring apparatus 3.

The monitoring apparatus 3 includes a CPU10, a storage section 11, and a communication interface 12. The CPU10 is a hardware processor that reads and executes the program 13 stored in the storage section 11. The storage section 11 is a non-volatile storage device constituted by, for example, a hard disk drive (HDD) or a solid state drive (SSD). The communication interface 12 is an interface that connects the monitoring apparatus 3 to the network 5 and communicates with the monitoring camera 2 and the mobile terminal 4.

The CPU 10 functions as a monitoring target setting 20 and a notification processing section 30 by executing the program 13. The monitoring target setting 20 is a processing section that associates the user with the belongings of the user and sets the belongings of the user as a monitoring target when the user enters the co-working space 7. For example, the monitoring target setting 20 communicates with the mobile terminal 4 carried by the user, and sets the monitoring target based on information acquired from the mobile terminal 4. The notification processing section 30 is a processing section that, upon detection of the occurrence of a security risk after the completion of the setting by the monitoring target setting 20, provides notification to the user.

The monitoring target setting 20 includes a registering section 21, belongings management 23, a specifying section 24, and a determiner 25.

The registering section 21 registers a user who works in the co-working space 7 in the monitoring apparatus 3. For example, the registering section 21 acquires information on the user from the mobile terminal 4 carried by the user and generates the user information 14. The information on the user includes a user name, a face image of the user, information on a group (such as a company or a department) to which the user belongs, and the like. The registering section 21 stores the user information 14 including these pieces of information in the storage section 11, thereby registering the user in the monitoring apparatus 3. The registering section 21 includes an acquirer 22. The acquirer 22 acquires the terminal information 15 from the mobile terminal 4 of the user. The terminal information 15 is information including a notification method, an address, and the like when performing notification to the mobile terminal 4. When the terminal information 15 is acquired by the acquirer 22, the registering section 21 registers the terminal information 15 in the user information 14.

The belongings management 23 detects the belongings placed in the work space 9 by the user based on the image obtained from the imaging section 6. For example, the belongings management 23 compares an image of the work space 9 captured by the imaging section 6 in a state where the user does not use the work space 9 with an image captured by the imaging section 6 after the user starts using the work space 9. No belongings of the user exist in the workspace 9 not used by the user. On the other hand, there is a possibility that the belongings of the user exists in the work space 9 after the user starts to use the work space 9. Therefore, the belongings management 23 can detect the user's belongings by extracting the difference between the image in a state not used by the user and the image in a state used by the user. When detecting belongings of a user, the belongings management 23 manages the belongings as a monitoring target. That is, the belongings management 23 cuts out the image of the belongings of the user as the monitoring target from the image captured by the imaging section 6, and records the monitoring target image in the monitoring target information 16 to manage the monitoring target image as the monitoring target.

The specifying section 24 specifies the type of the belongings of the user detected by the belongings management 23. For example, the specifying section 24 analyzes the monitoring target image cut out by the belongings management 23, and specifies to which of an information processing terminal such as a PC, a printed matter, a memo pad, a PET bottle, and an article such as a snack, the belongings of the user corresponds.

The determiner 25 determines, based on the type of the belongings specified by the specifying section 24, whether the belongings is an article including confidential information. When the belongings is an article including confidential information, the determinator 25 maintains a state in which the belongings of the user is registered as a monitoring target in the monitoring target information 16. On the other hand, when the belongings is an article that does not include confidential information, the determinator 25 deletes the belongings from the monitoring target information 16, and excludes the belongings from monitoring target by the monitoring apparatus 3.

The notification processing section 30 includes a first detector 31, a second detector 32, and a notification section 33.

The first detector 31 detects, based on an image captured by the imaging section 6, that the user has left the belongings placed in the workspace 9. The first detector 31 performs face authentication based on the image acquired from the imaging section 6 and constantly grasps the current position of the user. For example, the first detector 31 constantly measures the distance between the user and the user's belongings based on the image obtained from the imaging section 6 and, when the distance becomes a predetermined value or more, detects that the user has left the belongings. Furthermore, when the user disappears from the imaging range in a state where the belongings of the user remains in the workspace 9, the first detector 31 may detect that the user has left the belongings.

When the first detector 31 detects that the user has left the belongings, the notification processing section 30 causes the second detector 32 to function. The second detector 32 detects that another person different from the user as the owner has approached the belongings left in the workspace 9. In a case where a person appears in the image acquired from the imaging section 6, the second detector 32 performs face authentication and determines whether or not the person approaching the belongings left in the workspace 9 is the owner, the user. Then, the second detector 32 detects that another person different from the user approaches the belongings left in the work space 9. For example, when the person captured in the image acquired from the imaging section 6 is a person different from the user, the second detector 32 constantly measures the distance between the person different from the user and the belongings of the user, and when the distance becomes equal to or shorter than a predetermined value, detects that the person different from the user has approached the belongings of the user. Furthermore, the second detector 32 may detect that a person different from the user has approached the belongings of the user in a case where the person captured in the image acquired from the imaging section 6 is a person different from the user. In addition, in a case where a human body detection sensor is installed in the vicinity of the work space 9 used by the user, the second detector 32 may detect that a person different from the user approaches the belongings of the user when the human body detection sensor detects the person.

In a case where another person different from the user approaches the belongings of the user in a state where the user is away from the workspace 9, there is a possibility that the belongings of the user is browsed by another person and confidential information is leaked. Therefore, when it is detected, based on detection results of the first detector 31 and the second detector 32, that another person different from the user has approached the belongings of the user in a state where the user is away from the workspace 9, the notification processing section 30 causes the notification section 33 to function.

The notification section 33 notifies the user who is away from the workspace 9 that a security risk is occurring. That is, when it is detected that another person different from the user has approached the belongings of the user in a state where the user is away from the workspace 9, the notification section 33 notifies the mobile terminal 4 owned by the user that there is a possibility that confidential information will be leaked. At this time, the notification section 33 reads the terminal information 15 included in the user information 14 and specifies the mobile terminal 4 carried by the user. The notification method by the notification section 33 includes, for example, a method of transmitting an electronic mail and a method of transmitting a message. The notification section 33 notifies the mobile terminal 4 by a notification method defined in the terminal information 15. The mobile terminal 4 is always carried by a user. Therefore, even when the user is away from the workspace 9, the user can recognize that another person is approaching his/her belongings by the notification to the mobile terminal 4. As a result, the user can immediately return to the work space 9 to prevent leakage of confidential information.

Note that the notification section 33 may output sound from a speaker provided in the co-working space 7, for example, to give notification to the user, in addition to giving notification to the mobile terminal 4 of the user.

Furthermore, it is preferable that the notification section 33 refers to the monitoring target information 16 when it is detected that another person different from the user is approaching the belongings of the user in a state where the user is away from the workspace 9. That is, it is preferable that the notification section 33 refers to the monitoring target information 16 and performs notification to the user on condition that the belonging of the user left in the workspace 9 is determined to be an article including confidential information. For example, in a case where the belongings of the user left in the workspace 9 is a PET bottle containing a beverage, there is no possibility that confidential information leaks even if another user approaches the PET bottle. Therefore, in a case where the belongings of the user left in the work space 9 is an article that does not include confidential information, such as a PET bottle, the notification section 33 does not perform notification to the user. Thus, it is possible to prevent the notification from being frequently given to the user away from the work space 9.

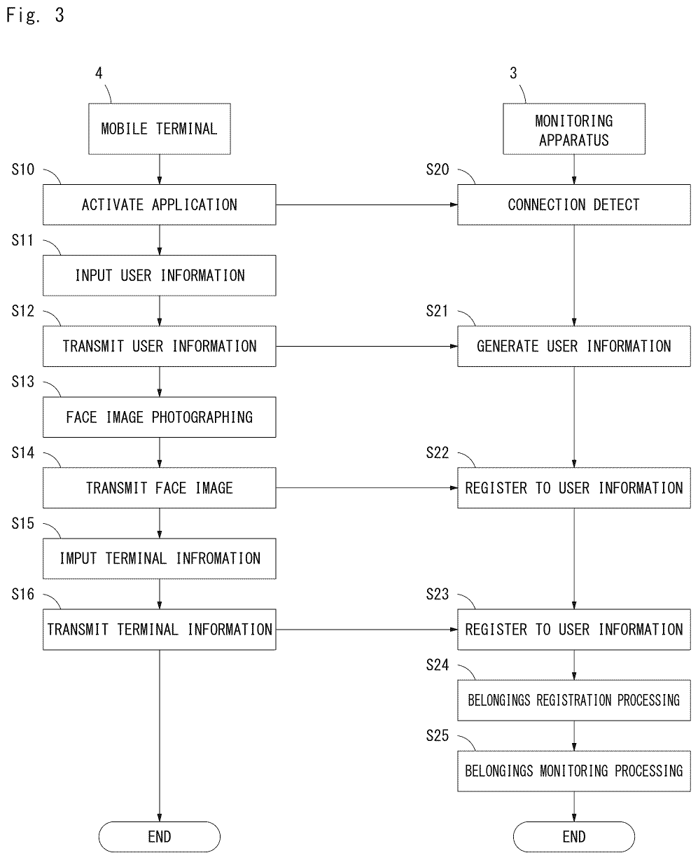

FIG. 3 is a flowchart illustrating a processing procedure by the mobile terminal 4 and the monitoring apparatus 3. Upon entering the co-working space 7, the user causes the mobile terminal 4 to activate an application that cooperates with the monitoring apparatus 3 (step S10). When the application is activated, the mobile terminal 4 transmits a connection request to the monitoring apparatus 3. Upon receiving the connection request from the application of the mobile terminal 4, the monitoring apparatus 3 detects the connection to the mobile terminal 4 and starts communication with the mobile terminal 4 (step S20).

When the communication with the monitoring apparatus 3 is started, the application of the mobile terminal 4 receives input of information on the user (step S11). The information on the user includes a user name, information on a group (such as a company or a department) to which the user belongs, and the like. When the information on the user is input, the mobile terminal 4 transmits the information on the user to the monitoring apparatus 3. Upon acquiring the information on the user from the mobile terminal 4, the monitoring apparatus 3 generates the user information 14 and stores it in the storage section 11 (step S21).

Next, the application of the mobile terminal 4 activates the camera function of the mobile terminal 4, and captures a face image of the user (step S13). The face image of the user is used for face authentication for identifying the same person. The mobile terminal 4 transmits the face image of the user captured by the application to the monitoring apparatus 3 (step S14). Upon acquiring the face image of the user from the mobile terminal 4, the monitoring apparatus 3 registers the face image in the user information 14 (step S22).

Next, the application of the mobile terminal 4 receives user's input of the terminal information 15 (step S15). The terminal information 15 is information describing a notification method, an address, and the like when the monitoring apparatus 3 performs notification with the mobile terminal 4. When the terminal information 15 is input by the user, the mobile terminal 4 transmits the terminal information 15 to the monitoring apparatus 3 (step S16). The mobile terminal 4 may automatically generate the terminal information 15 and transmit it to the monitoring apparatus 3. Upon acquiring the terminal information 15 from the mobile terminal 4, the monitoring apparatus 3 registers the terminal information 15 in the user information 14 (step S23).

Through the above-described processing, the monitoring apparatus 3 completes the registration of the information on the user who uses the co-working space 7 and the information on the mobile terminal 4 used by the user.

Next, the monitoring apparatus 3 performs belongings registration processing for registering the belongings of the user (step S24). The belongings registration processing is processing for registering a user's belongings that the user places on a table or the like in the workspace 9, in association with the user. In the belongings registration processing, the above-described belongings management 23, the specifying section 24, and the determinator 25 function. For example, when a user takes an information processing terminal such as a PC out of a bag and places it on a table in the workspace 9, the monitoring apparatus 3 detects the information processing terminal based on the image obtained from the imaging section 6. The monitoring apparatus 3 associates the detected information processing terminal with the user and registers the information processing terminal as a belonging of the user. When the user takes out a PET bottle containing a beverage from the bag and places the PET bottle on the table in the work space 9, the monitoring apparatus 3 detects the PET bottle based on the image obtained from the imaging section 6. The monitoring apparatus 3 associates the detected PET bottle with the user and registers the PET bottle as a belonging of the user.

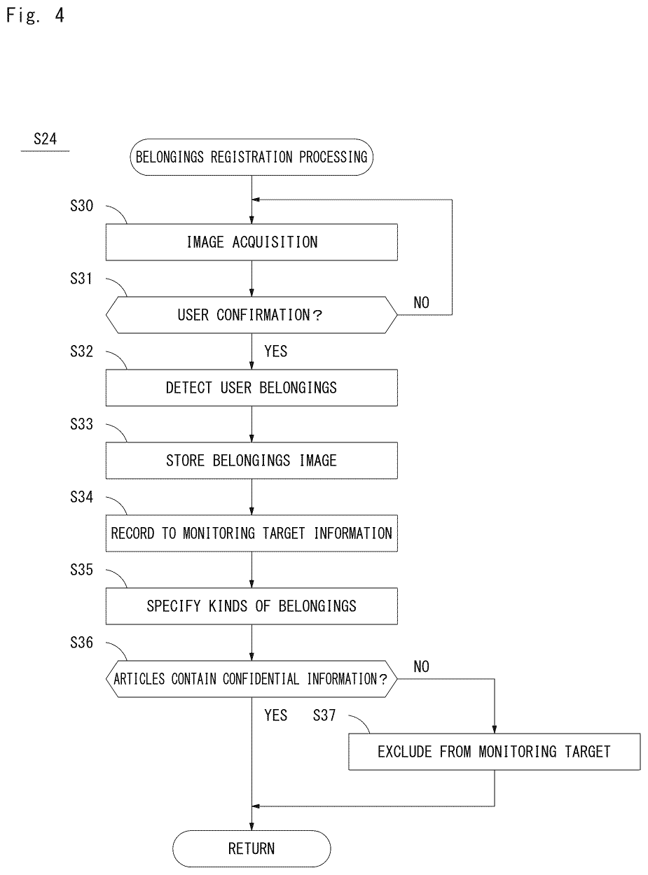

FIG. 4 is a flowchart illustrating an example of a detailed processing procedure of the belongings registration processing (step S24). The monitoring apparatus 3 acquires an image captured by the imaging section 6 (step S30). Upon acquiring the image, the monitoring apparatus 3 performs facial authentication and checks whether or not the user registered in the user information 14 is present in the workspace 9 (step S31). When the user is present in the workspace 9 (YES in step S31), the monitoring apparatus 3 detects the user's belongings placed in the workspace 9 by the user (step S32).

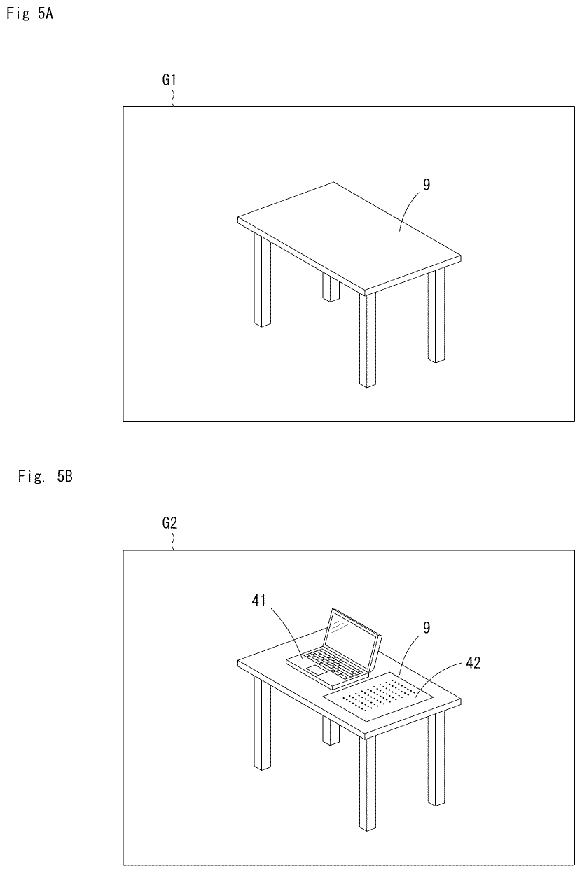

FIGS. 5A and 5B illustrate an example in which the monitoring apparatus 3 detects belongings of a user. For example, as illustrated in FIG. 5A, the monitoring apparatus 3 stores an image G1 captured by the imaging section 6 in a state where the workspace 9 is not used by the user. Thereafter, when the use of the work space 9 is started by the user, the monitoring apparatus 3 acquires an image G2 as illustrated in FIG. 5B from the imaging section 6. The monitoring apparatus 3 extracts the difference between the image G1 and the image G2, and detects the belongings of the user. In the example of FIG. 5B, the monitoring apparatus 3 detects an information processing terminal 41 and a printed matter 42 as belongings of the user.

Upon detecting the belongings of the user, the monitoring apparatus 3 stores the image of the belongings (step S33) and records the belongings of the user in the monitoring target information 16 (step S34). Thus, the belongings of the user included in the image obtained from the imaging section 6 is registered as a monitoring target. At this time, the monitoring apparatus 3 registers the user's belongings in the monitoring target information 16 in a state of being associated with the user.

Subsequently, the monitoring apparatus 3 specifies the type of the user's belongings (step S35). Here, the specifying section 24 functions in the monitoring apparatus 3 as described above. The specifying section 24 then specifies which of the belongings, such as an information processing terminal, a printed matter, a memo pad, a PET bottle, and a snack, the user's belongings correspond to.

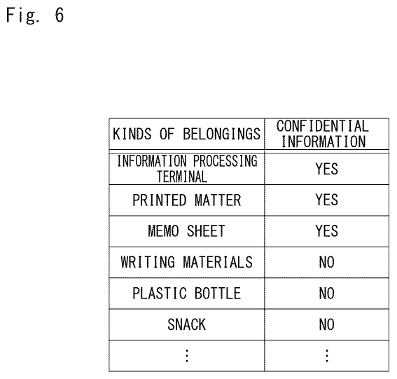

Next, the determinator 25 functions in the monitoring apparatus 3. The determinator 25 determines whether or not the belongings specified by the specifying section 24 is an article containing confidential information (step S36). At this time, the determinator 25 refers to the reference information illustrated in FIG. 6. The reference information illustrated in FIG. 6 is information in which the type of belongings and the presence or absence of confidential information are associated with each other in advance. For example, the reference information in FIG. 6 defines that if the user's belongings are an information processing terminal, a printed matter, and a memo pad, they are articles including confidential information. Furthermore, the reference information in FIG. 6 defines that if the belongings of the user are a writing instrument, a PET bottle, and a snack, they are articles that do not include confidential information. The determinator 25 determines whether or not the belongings of the user is an article including confidential information by referring to such reference information.

Alternatively, for example, the determiner 25 may analyze the image captured by the imaging section 6 to determine whether or not the user's belongings include confidential information. For example, the determiner 25 may determine whether or not the belongings of the user includes confidential information by analyzing whether or not the belongings of the user includes a character string such as “classified” or “Confidential”.

In a case where the belongings of the user is an article including confidential information (YES in step S36), the monitoring apparatus 3 ends the processing in a state where the belongings of the user is registered as a monitoring target. On the other hand, when the belongings of the user is an article that does not include confidential information (NO in step S36), the monitoring apparatus 3 excludes the belongings of the user from the monitoring target (step S37). That is, the monitoring apparatus 3 deletes the belongings of the user registered in the monitoring target information 16 from the monitoring target information 16. Thus, the belongings registration processing (step S24) ends.

Return to FIG. 4. Next, the monitoring apparatus 3 performs belongings monitoring processing for monitoring whether or not a security risk has occurred in the belongings of the user (step S25). The belongings monitoring processing is processing of determining whether or not another person different from the user is approaching the user's belongings left in the workspace 9 while the user is away from the workspace 9 and providing a notification to the user when a security risk is increasing. The notification processing section 30 described above functions in the belongings monitoring processing. For example, the notification processing section 30 analyzes images sequentially acquired from the image sensing section 6 and provides a notification to the user when the possibility of leakage of confidential information increases.

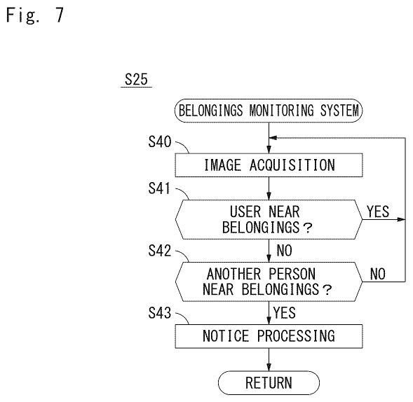

FIG. 7 is a flowchart illustrating an example of a detailed processing procedure of belongings monitoring processing (step S25). The notification processing section 30 first causes the first detector 31 to function. The first detector 31 acquires the image captured by the imaging section 6 (step S40) and determines whether or not the user who is the owner is present near the belongings of the user placed in the workspace 9 (step S41). For example, when the distance between the user and the belongings of the user measured based on the image obtained from the imaging section 6 is less than a predetermined value, the first detector 31 determines that the user who is the owner exists near the belongings of the user. On the other hand, when the distance between the user and the belongings of the user measured based on the image obtained from the imaging section 6 is equal to or more than the predetermined value, the first detector 31 determines that the user who is the owner does not exist near the belongings of the user.

In a case where the user who is the owner is present near the belongings of the user (YES in step S41), the processing performed by the notification processing section 30 returns to step S40, and the above-described processing is repeated. On the other hand, when the user who is the owner does not exist near the belongings of the user (NO in step S41), the notification processing section 30 causes the second detector 32 to function. The second detector 32 analyzes, for example, the image acquired from the imaging section 6 and determines whether or not another person different from the user is present near the belongings of the user (step S42).

When another person different from the user is not present near the belongings of the user (NO in step S42), the processing performed by the notification processing section 30 returns to step S40, and the above-described processing is repeated. On the other hand, in a case where another person different from the user is present near the belongings of the user (YES in step S42), the second detector 32 determines that there is a possibility of leakage of confidential information. In this case, the notification processing section 30 causes the notification section 33 to function. The notification section 33 provides a notification to the user when another person is approaching belongings of the user left in the workspace 9 while the user is away from the workspace 9 (step S43). For example, the notification section 33 transmits, to the mobile terminal 4, a message indicating that the security risk is increasing.

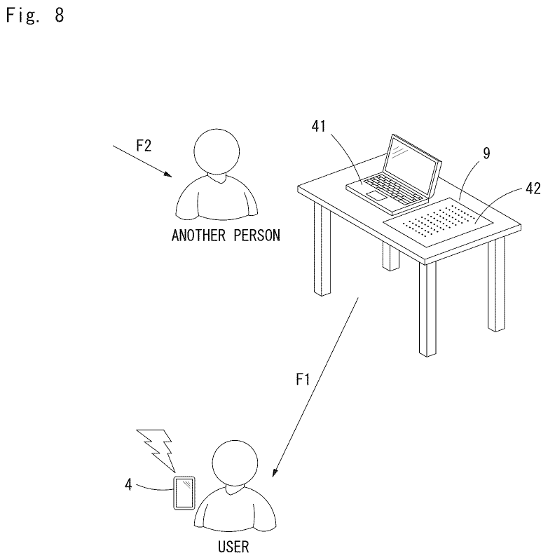

FIG. 8 illustrates a concept of processing by the notification processing section 30. When the user working in the workspace 9 leaves the workspace 9 as indicated by an arrow F1, the first detector 31 detects that the user has left his or her belongings. Thereafter, when another person approaches the belongings of the user left in the work space 9 as indicated by an arrow F2 in a state where the user is away from the work space 9, the second detector 32 detects that a risk of leakage of confidential information has occurred. Next, the notification section 33 provides a notification to the mobile terminal 4 of the user who is away from the workspace 9. Thus, the user can immediately return to the workspace 9, thereby preventing leakage of confidential information.

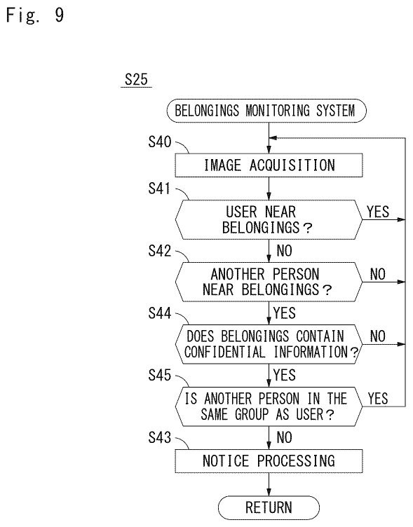

Incidentally, in the processing procedure illustrated in FIG. 7, even if the belongings left in the workspace 9 by the user is an article that does not include confidential information, when another person approaches the belongings, a notification is provided to the mobile terminal 4 of the user. Furthermore, even if a person who approaches the belongings of the user belongs to the same group as the user, a notification is provided to the mobile terminal 4 of the user when the person approaches the belongings of the user. In any of these cases, there is no possibility that confidential information leaks. Therefore, in these cases, it is not preferable that the monitoring apparatus 3 provides a notification to the mobile terminal 4 of the user. Therefore, the processing procedure illustrated in FIG. 9 may be adopted instead of the processing procedure illustrated in FIG. 7.

FIG. 9 is a flowchart illustrating an example of detailed processing procedure of belongings monitoring processing (step S25) different from FIG. 7. Note that in FIG. 9, steps S40 to S42 are the same processing as steps S40 to S42 illustrated in FIG. 7.

When it is detected that there is another person different from the user near the belongings of the user in a state where the user is away from the belongings (YES in step S42), the notification processing section 30 causes the notification section 33 to function. The notification section 33 determines whether or not the user's belongings left in the workspace 9 include confidential information (step S44). For example, the notification section 33 refers to the monitoring target information 16, and determines whether the belongings of the user includes confidential information according to whether the belongings that the user leaves in the workspace 9 is registered in the monitoring target information 16.

If the belongings that the user has left in the workspace 9 is an article that does not include confidential information (NO in step S44), the notification section 33 does not provide notification to the user's mobile terminal 4. In this case, the processing by the monitoring apparatus 3 returns to step S40.

On the other hand, if the belongings that the user has left in the workspace 9 includes confidential information (YES in step S44), the notification section 33 performs facial authentication of another person who approaches the belongings of the user, and determines whether or not the other person is a person who belongs to the same group as the user (step S45). At this time, the notification section 33 reads, from the storage section 11, the user information 14 on another person who approaches the belongings of the user, and specifies the group to which another person belongs. Next, the notification section 33 determines whether or not the group to which the user belongs and the group to which another person belongs are the same group by comparing them.

When another person who approaches the belongings of the user belongs to the same group as the user (YES in step S45), there is no possibility that the confidential information leaks to the outside. Therefore, the notification section 33 does not provide a notification to the mobile terminal 4 of the user. In this case, the processing by the monitoring apparatus 3 returns to step S40.

On the other hand, when another person who approaches the belongings of the user does not belong to the same group as the user (NO in step S45), the notification section 33 makes a notification to the mobile terminal 4 of the user (step S43). Thus, the user can immediately return to the workspace 9, thereby preventing leakage of confidential information.

In this way, the monitoring apparatus 3 determines whether the belongings that the user has left behind in the workspace 9 includes confidential information and also determines whether the person who approaches the belongings of the user belongs to the same group as the user, thereby avoiding frequent notification to the mobile terminal 4 of the user. Furthermore, the monitoring apparatus 3 can make a notification to the mobile terminal 4 only when there is a possibility that confidential information will leak to the outside. Therefore, the monitoring system 1 is implemented as a more convenient system.

When transmitting the notification to the mobile terminal 4, the notification section 33 may transmit the image captured by the imaging section 6 to the mobile terminal 4. By transmitting the image to the mobile terminal 4, the user can immediately grasp the surrounding situation of the workspace 9. Therefore, if a person unknown to the user stays in the vicinity of the workspace 9, the user becomes aware of it and immediately comes back to the workspace 9. In addition, when the notification section 33 transmits an image to the mobile terminal 4, the notification section 33 preferably transmits an image immediately before detection by the second detector 32.

### Second Embodiment

Next, a second embodiment of the present invention will be described. In the first embodiment, an example has been described in which the first detector 31 detects that the user has left the belongings of the user based on the image captured by the imaging section 6, the second detector 32 detects that another person different from the user has approached the belongings of the user, and the notification section 33 notifies the user when the first detector 31 detects that the user has left the belongings of the user and the second detector 32 detects that another person has approached the belongings of the user. On the other hand, in the second embodiment, an example will be described in which the second detector 32 detects that the belongings of the user has moved within the imaging range based on the image captured by the imaging section 6, and the notification section 33 notifies the user when the first detector 31 detects that the user has separated from the belongings of the user and the second detector 32 detects that the belongings of the user has moved. The configuration of the monitoring system 1 of the present embodiment is the same as that described in the first embodiment.

The second detector 32 of the present embodiment detects that the belongings of the user has moved based on the image captured by the imaging section 6. For example, the second detector 32 holds the image captured by the imaging section 6 for a predetermined time, and compares the images before and after the predetermined time has elapsed, thereby determining whether or not the position of the belongings of the user illustrated in the image has changed. When the position where the belongings of the user is reflected is changing, the second detector 32 detects that the belongings of the user has moved. Furthermore, when the belongings of the user disappears from the image captured by the imaging section 6, the second detector 32 may detect that the belongings of the user has moved.

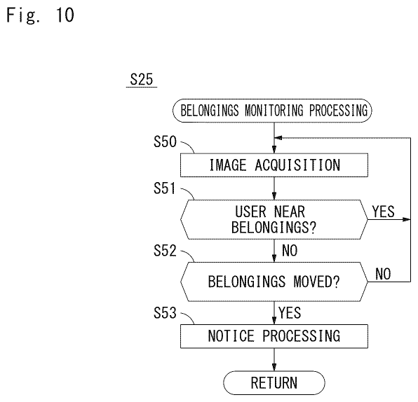

FIG. 10 is a flowchart illustrating an example of a detailed processing procedure of the belongings monitoring processing (step S25) in the second embodiment. The notification processing section 30 first causes the first detector 31 to function. As in the first embodiment, the first detector 31 acquires an image captured by the imaging section 6 (step S50), and determines whether or not a user who is the owner is present near the belongings of the user placed in the workspace 9 (step S51). In a case where the user who is the owner is present near the belongings of the user (YES in step S51), the process performed by the notification processing section 30 returns to step S40, and the above-described processing is repeated. On the other hand, when the user who is the owner does not exist near the belongings of the user (NO in step S51), the notification processing section 30 causes the second detector 32 to function.

The second detector 32 analyzes, for example, the image acquired from the imaging section 6 and determines whether or not the belongings of the user has moved (step S52). If the belongings of the user has not moved (NO in step S52), the processing by the notification processing section 30 returns to step S50, and the above-described processing is repeated. On the other hand, when the belongings of the user has moved (YES in step S52), the second detector 32 determines that there is a possibility of leakage of confidential information. In this case, the notification processing section 30 causes the notification section 33 to function.

If the user's belonging left in the workspace 9 has moved while the user is away from the workspace 9, the notification section 33 provides a notification to the user (step S53).

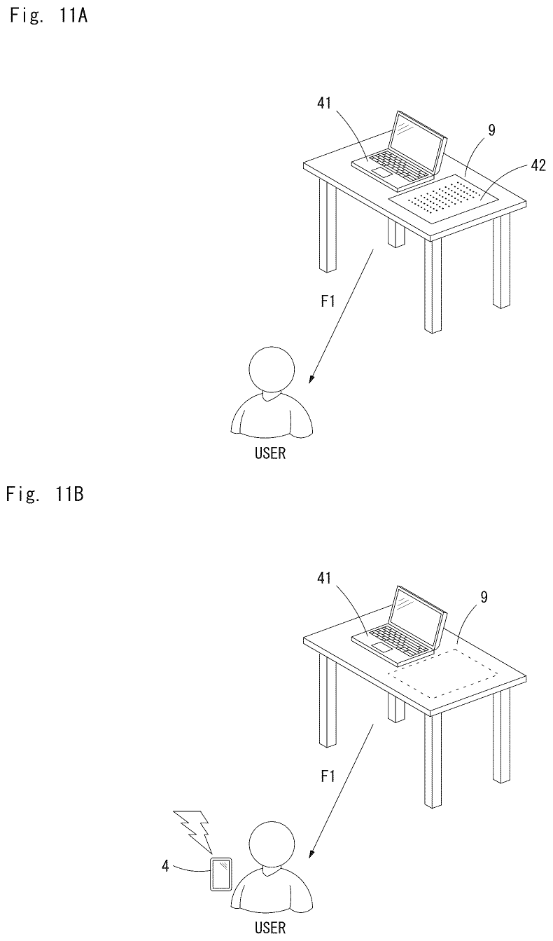

FIG. 11A and FIG. 11B illustrate the concept of processing by the notification processing section 30. For example, as illustrated in FIG. 11A, when the user who has worked in the workspace 9 moves away from the workspace 9 as indicated by an arrow F1, the first detector 31 detects that the user has moved away from his/her belongings. Thereafter, in a state where the user is away from the workspace 9, as illustrated in FIG. 11B, the printed matter 42 placed in the workspace 9 may move and disappear from the workspace 9. Such a phenomenon may occur, for example, when the printed matter 42 is blown by the wind of the air conditioner. If the printed matter 42 is blown, the printed matter may be acquired by another person and confidential information may be leaked. Therefore, the notification section 33 transmits, to the mobile terminal 4 of the user away from the workspace 9, a message indicating that the security risk is increasing.

As described above, if the belongings of the user moves, the monitoring system 1 according to the present embodiment detects the movement and provides a notification to the mobile terminal 4 of the user even if another person does not approach the workspace 9 without the user. With this notification, the user can immediately return to the work space 9 and collect the moved belongings by himself/herself, thereby preventing leakage of confidential information.

When transmitting the notification to the mobile terminal 4, the notification section 33 may transmit the image captured by the imaging section 6 to the mobile terminal 4. By transmitting the image to the mobile terminal 4, the user can immediately grasp that his or her belongings left in the workspace 9 is moving. Therefore, the user immediately comes back to the workspace 9. In addition, when the notification section 33 transmits an image to the mobile terminal 4, the notification section 33 preferably transmits an image immediately before detection by the second detector 32. The user can ascertain the presence or absence of the possibility that another person has carried away his or her belongings by checking the image immediately before the detection by the second detector 32.

Note that the other points are the same as those described in the first embodiment. For example, the monitoring apparatus 3 may provide a notification to the mobile terminal 4 of the user only when the belongings moved from the workspace 9 is an article including confidential information.

### Modification Example

A preferred embodiment of the present invention has been described above. However, the present invention is not limited to the content described in the above embodiment, and various modification examples are applicable.

For example, in the embodiment, it has been described that the specifying section 24 analyzes the monitoring target image cut out by the belongings managing section 23 to specify the type of the belongings of the user. However, the specifying section 24 might not necessarily perform image analysis when specifying the type of the user's belongings. For example, when the user places belongings in the workspace 9, a sound corresponding to a feature of the belongings is generated. The monitoring apparatus 3 may acquire a sound emitted by the belongings with a microphone (not illustrated) and analyze the sound to specify the type of the belongings. Furthermore, the specifying section 24 may specify the type of the belongings of the user based on the information other than images and sounds.

Further, the program 13 described in the above embodiment is not limited to a program stored in advance in the storage section 11 of the monitoring apparatus 3. For example, the program 13 may be a transaction target by itself. In this case, the program 13 may be provided in a mode of being downloadable via a network such as the Internet, or may be provided in a state of being recorded in a computer-readable recording medium such as a CD-ROM.

Although embodiments of the present invention have been described and illustrated in detail, the disclosed embodiments are made for purposes of illustration and example only and not limitation. The scope of the present invention should be interpreted by terms of the appended claims.

What is claimed is:

1. A monitoring system, comprising:
an imaging section that captures an image of a user present within a predetermined image capturing range and belongings of the user; and
a hardware processor, wherein
the hardware processor executes:
detecting that the user has left the belongings based on the image captured by the imaging section;
detecting that another person different from the user has approached the belongings; and
notifying the user when it is detected that the user has left the belongings and it is detected that another person different from the user has approached the belongings.

2. A monitoring system, comprising:
an imaging section that captures an image of a user present within a predetermined image capturing range and belongings of the user; and
a hardware processor, wherein
the hardware processor executes:
detecting that the user has left the belongings based on the image captured by the imaging section;
detecting that the belongings has moved within the imaging range based on the image captured by the imaging section; and
notifying the user when it is detected that the user has left the belongings and it is detected that the belongings has moved.

3. The monitoring apparatus according to claim 1, further comprising:
an acquirer that acquires terminal information regarding a mobile terminal possessed by the user, wherein
the hardware processor provides a notification to the mobile terminal possessed by the user based on the terminal information.

4. The monitoring apparatus according to claim 3, wherein
when the hardware processor provides the notification to the mobile terminal, the hardware processor transmits an image captured by the imaging section to the mobile terminal.

5. The monitoring system according to claim 4, wherein
the hardware processor transmits, to the mobile terminal, an image immediately before it is detected that another person different from the user has approached the belongings.

6. The monitoring system according to claim 1, wherein
the hardware processor further executes:
registering the user; and
managing the registered user and the belongings of the user in association with each other based on the image captured by the imaging section.

7. The monitoring system according to claim 6, wherein
the hardware processor registers at least a face image of the user when registering the user.

8. The monitoring system according to claim 1, wherein
the hardware processor detects that another person different from the user has approached the belongings based on the image captured by the imaging section.

9. The monitoring system according to claim 2, wherein
the hardware processor detects that the belongings has moved when the belongings disappears from the image captured by the imaging section.

10. The monitoring system according to claim 1, wherein
the hardware processor further executes:
specifying a type of the belongings present in the imaging range; and
determining whether or not the belongings is an article including confidential information based on the type of the belongings; wherein
the hardware processor notifies the user when the hardware processor determines that the belongings is an article including confidential information.

11. The monitoring system according to claim 10, wherein
the hardware processor analyzes the image captured by the imaging section to specify the type of the belongings.

12. The monitoring system according to claim 1, wherein
the hardware processor registers information related to a group to which the user belongs, and
when detecting that another person has approached the belongings, it does not notify the user when the another person belongs to the same group as the user.

13. A non-transitory computer-readable recording medium storing a program executed in a monitoring system comprising an imaging section that captures an image of a user and belongings of the user present in a predetermined image capturing range, the program causing the monitoring system to perform:
detecting that the user has left the belongings based on an image captured by the imaging section;
detecting that the belongings has moved within the imaging range based on an image captured by the imaging section; and
notifying to the user when it is detected that the user has left the belongings and it is detected that the belongings has moved.
